(19) United States
(12) Patent Application Publication
(10) Pub. No.: US 2025/0319448 A1
(43) Pub. Date: Oct. 16, 2025

(54) METHODS AND INTERNET OF THINGS (IoT) SYSTEMS FOR GAS MIXING STATION EQUIPMENT MONITORING BASED ON SMART GAS

(71) Applicant: CHENGDU QINCHUAN IOT TECHNOLOGY CO., LTD., Chengdu (CN)

(72) Inventors: Zehua SHAO, Chengdu (CN); Yong LI, Chengdu (CN); Jun WANG, Chengdu (CN); Guanghua HUANG, Chengdu (CN); Lei ZHANG, Chengdu (CN)

(73) Assignee: CHENGDU QINCHUAN IOT TECHNOLOGY CO., LTD., Chengdu (CN)

(21) Appl. No.: 19/178,824

(22) Filed: Apr. 14, 2025

(30) Foreign Application Priority Data
Mar. 25, 2025 (CN) 202510354679.2

(51) Int. Cl. B01F 35/22; B01F 35/213; G16Y 10/35; G16Y 40/10; G16Y 40/30

(52) U.S. Cl. CPC B01F 35/2202; B01F 35/213; G16Y 10/35; G16Y 40/10; G16Y 40/30

(57) ABSTRACT

Disclosed a method and an IoT system for gas mixing station equipment monitoring based on smart gas. The method is implemented by a gas company management platform of the IoT system for gas mixing station equipment monitoring based on smart gas, comprising: obtaining state data of a gas to be mixed; determining a gas mixing parameter; obtaining gas composition data; in response to the gas composition data not satisfying a preset condition, determining an updated gas mixing parameter by performing at least one iterative update on the gas mixing parameter; determining, based on output composition data of output gas and downstream pipeline data, a gas transportation parameter; and updating a gas database based on the gas mixing parameter and/or the updated gas mixing parameter, the gas transportation parameter, the downstream pipeline data, the output composition data, and received composition data of a mixed gas received by a downstream gas pipeline.

### CROSS-REFERENCE TO RELATED APPLICATIONS

This application claims priority to Chinese Application No. 202510354679.2, filed on Mar. 25, 2025, the entire contents of which are incorporated herein by reference.

### TECHNICAL FIELD

The present disclosure relates to the field of gas mixing station monitoring, and in particular to a method and an Internet of Things (IoT) system for gas mixing station equipment monitoring based on smart gas.

### BACKGROUND

A gas mixing station is equipped with a storage device, a gasification device and a gas mixing device which can convert liquid natural gas or liquefied petroleum gas into a gaseous state to be mixed with air or other combustible gases in a certain proportion to formulate a mixed gas, and finally supply the gas to users. However, in the process of gas mixing at the gas mixing station, there is often an issue of non-uniform mixing, and in the process of transporting the mixed gas, there may be a risk of the mixed gas becoming non-uniform again, which subsequently affects gas usage of the users.

It is therefore desirable to provide a method and an IoT system for gas mixing station equipment monitoring based on smart gas capable of monitoring the uniformity of the mixed gas in time to ensure that the mixed gas remains relatively uniform during gas mixing and transportation.

### SUMMARY

One or more embodiments of the present disclosure provide a method for gas mixing station equipment monitoring based on smart gas, implemented by a gas company management platform of an Internet of Things (IoT) system for gas mixing station equipment monitoring based on smart gas. The method may comprise obtaining state data of a gas to be mixed through a gas company sensor network platform and an equipment object platform, the equipment object platform including a state monitoring device; determining a gas mixing parameter based on the state data and a mixing proportion; generating a mixing instruction based on the gas mixing parameter and sending the mixing instruction to the equipment object platform, the equipment object platform further including a gas mixing device; obtaining gas composition data of at least one preset point position of the gas mixing device during a process of the gas mixing device performing gas mixing based on the mixing instruction; in response to determining that the gas composition data does not satisfy a preset condition, determining an updated gas mixing parameter by performing at least one iterative update on the gas mixing parameter based on the gas composition data; generating an updated gas mixing instruction based on the updated gas mixing parameter and sending the updated gas mixing instruction to the gas mixing device, the gas mixing device performing gas mixing based on the updated gas mixing instruction to obtain an output gas; determining, based on output composition data of the output gas and downstream pipeline data, a gas transportation parameter through a gas database, the gas database being configured in a government data center; and updating, based on the gas mixing parameter and/or the updated gas mixing parameter, the gas transportation parameter, the downstream pipeline data, the output composition data, and received composition data of a mixed gas received by a downstream gas pipeline, the gas database.

One or more embodiments of the present disclosure provide an Internet of Things (IoT) system for gas mixing station equipment monitoring based on smart gas. The IoT system may comprise a government safety supervision management platform, a government safety supervision sensor network platform, a government safety supervision object platform, a gas company sensor network platform, and an equipment object platform. The government safety supervision management platform may include a government data center. The government safety supervision object platform may include a gas company management platform. The gas company management platform may be configured to: obtain state data of a gas to be mixed through the gas company sensor network platform and the equipment object platform, the equipment object platform including a state monitoring device; determine a gas mixing parameter based on the state data and a mixing proportion; generate a mixing instruction based on the gas mixing parameter and send the mixing instruction to the equipment object platform, the equipment object platform further including a gas mixing device; obtain gas composition data of at least one preset point position of the gas mixing device during a process of the gas mixing device performing gas mixing based on the mixing instruction; in response to determining that the gas composition data does not satisfy a preset condition, determine an updated gas mixing parameter by performing at least one iterative update on the gas mixing parameter based on the gas composition data; generate an updated gas mixing instruction based on the updated gas mixing parameter and send the updated gas mixing instruction to the gas mixing device, the gas mixing device performing gas mixing based on the updated gas mixing instruction to obtain an output gas; determine, based on output composition data of the output gas and downstream pipeline data, a gas transportation parameter through a gas database, the gas database being configured in the government data center; and update, based on the gas mixing parameter and/or the updated gas mixing parameter, the gas transportation parameter, the downstream pipeline data, the output composition data, and received composition data of a mixed gas received by a downstream gas pipeline, the gas database.

One or more embodiments of the present disclosure provide a non-transitory computer-readable storage medium comprising one or more sets of computer instructions that, when read by a computer, may direct the computer to implement the method for gas mixing station equipment monitoring based on smart gas.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering indicates the same structure, wherein:

FIG. 1 is a schematic structural diagram illustrating platforms of an Internet of Things (IoT) for gas mixing station equipment monitoring based on smart gas according to some embodiments of the present disclosure;

FIG. 2 is a flowchart illustrating an exemplary method for gas mixing station equipment monitoring based on smart gas according to some embodiments of the present disclosure;

FIG. 3 is a flowchart illustrating a process of determining an updated gas mixing parameter according to some embodiments of the present disclosure; and

FIG. 4 is a schematic diagram illustrating an exemplary transportation model according to some embodiments of the present disclosure.

### DETAILED DESCRIPTION

In order to more clearly illustrate the technical solutions of the embodiments of the present disclosure, the accompanying drawings, which are to be used in the description of the embodiments, will be briefly described below. The accompanying drawings do not represent the entirety of the embodiments.

It should be understood that the terms “system,” “device,” “unit” and/or “module” used herein are a way to distinguish between different components, elements, parts, sections, or assemblies at different levels. However, the terms may be replaced by other expressions if other words accomplish the same purpose.

As shown in the present disclosure and in the claims, unless the context clearly suggests an exception, the words “one,” “a,” “an,” “one kind,” and/or “the” do not refer specifically to the singular, but may also include the plural. Generally, the terms “including” and “comprising” suggest only the inclusion of clearly identified steps and elements, however, the steps and elements that do not constitute an exclusive list, and the method or apparatus may also include other steps or elements.

When describing the operations performed in the embodiments of the present disclosure in steps, the order of the steps is all interchangeable if not otherwise specified, the steps may be omitted, and other steps may be included in the process of operation.

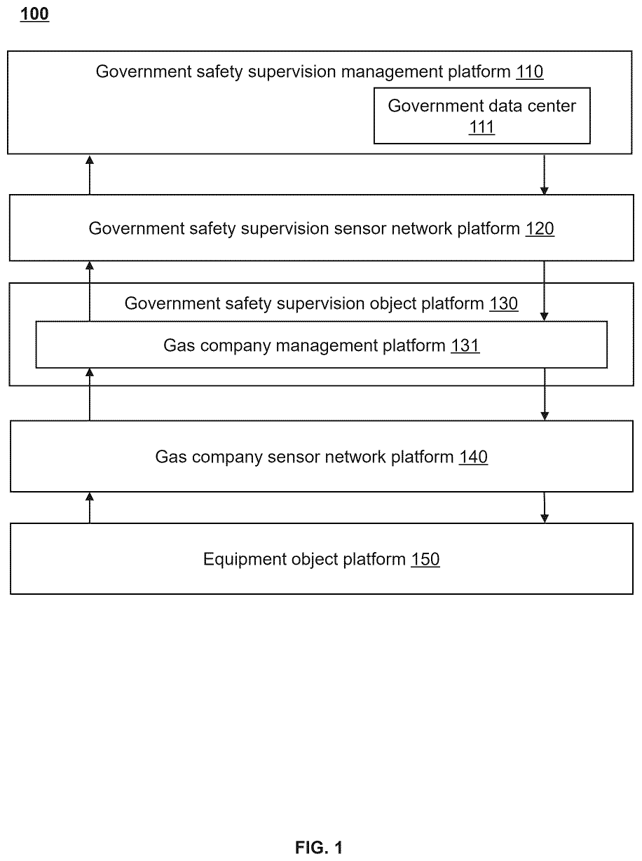

FIG. 1 is a schematic structural diagram illustrating platforms of an Internet of Things (IoT) system for gas mixing station equipment monitoring based on smart gas according to some embodiments of the present disclosure.

As shown in FIG. 1, an IoT system 100 for gas mixing station equipment monitoring based on smart gas may include a government safety supervision management platform 110, a government safety supervision sensor network platform 120, a government safety supervision object platform 130, a gas company sensor network platform 140, and an equipment object platform 150.

The government safety supervision management platform 110 refers to a comprehensive management platform for government information management. In some embodiments, the government safety supervision management platform 110 may include a government data center 111.

The government data center 111 refers to a data center for storing data of the IoT system 100 for gas mixing station equipment monitoring based on smart gas. For example, the government data center stores a gas database. The gas database may be a database management system that supports high concurrent access, such as MySQL, PostgreSQL, Oracle, etc.

The government safety supervision sensor network platform 120 refers to a platform for comprehensive management of government sensor information. In some embodiments, the government safety supervision sensor network platform may interact with the government safety supervision object platform and the government safety supervision management platform. The government safety supervision sensor network platform may be configured as a communication network or a gateway, etc.

The government safety supervision object platform 130 refers to a platform for government supervision information generation and control information execution. In some embodiments, the government safety supervision object platform 130 may include a gas company management platform 131. The gas company management platform 131 refers to a comprehensive management platform for gas company information. The gas company management platform 131 may be configured to process data from the IoT system 100 for gas mixing station equipment monitoring based on smart gas.

The gas company sensor network platform 140 refers to a platform for comprehensive management of sensor information of a gas company. In some embodiments, the gas company sensor network platform may be configured as a communication network or a gateway, etc. The gas company sensor network platform may interact with the government safety supervision object platform and the equipment object platform.

The equipment object platform 150 refers to a functional platform for perceptual information generation and control information execution. In some embodiments, the equipment object platform may include at least one of a state monitoring device, a gas mixing device, a composition detection device, etc. The state monitoring device and the gas mixing device may be disposed in a gas mixing station. The composition detection device may be disposed in the gas mixing station, the gas mixing device, and/or a gas pipeline.

The gas mixing station refers to a gas supply facility in a gas output pipeline network that mixes gaseous liquefied petroleum gas (GLP) with air and/or other combustible gases to formulate a mixed gas and supply the gas to users. The users refer to residents and/or businesses, or the like, that use the gas.

The state monitoring device may be configured to collect state data of a gas to be mixed. In some embodiments, the state monitoring device may include a temperature sensor, a pressure sensor, a plurality of composition sensors, etc. One of the composition sensors may be configured to collect composition data of one gas to be mixed.

The gas mixing device refers to a device for mixing the gas to be mixed.

The composition detection device refers to a device for obtaining gas composition data of a mixed gas. In some embodiments, the composition detection device may be disposed on at least one preset point position of the gas mixing device, and may also be disposed at a gas outlet of the gas mixing station, etc.

In some embodiments, the composition detection device may include a sampling device and a composition sensor. The sampling device refers to a device for sampling the mixed gas. The composition sensor refers to a sensor for detecting the gas composition data. The composition sensor may be configured to obtain the gas composition data by detecting the mixed gas sampled by the sampling device. The mixed gas refers to a gas obtained by the gas mixing device performing gas mixing on the gas to be mixed.

In some embodiments, the IoT system 100 for gas mixing station equipment monitoring based on smart gas may further include a server. The server may be configured to process information and/or data related to the IoT system 100 for gas mixing station equipment monitoring based on smart gas to implement one or more of the functions described in the present disclosure.

In some embodiments, the server may include a processor, a memory, a storage device, and a network. The storage device may include a high-speed SSD to support database operation and data backup. The processor may include a central processing unit (CPU), an application-specific integrated circuit (ASIC), an application-specific instruction processor (ASIP), a graphics processor (GPU), or the like, or any combination thereof.

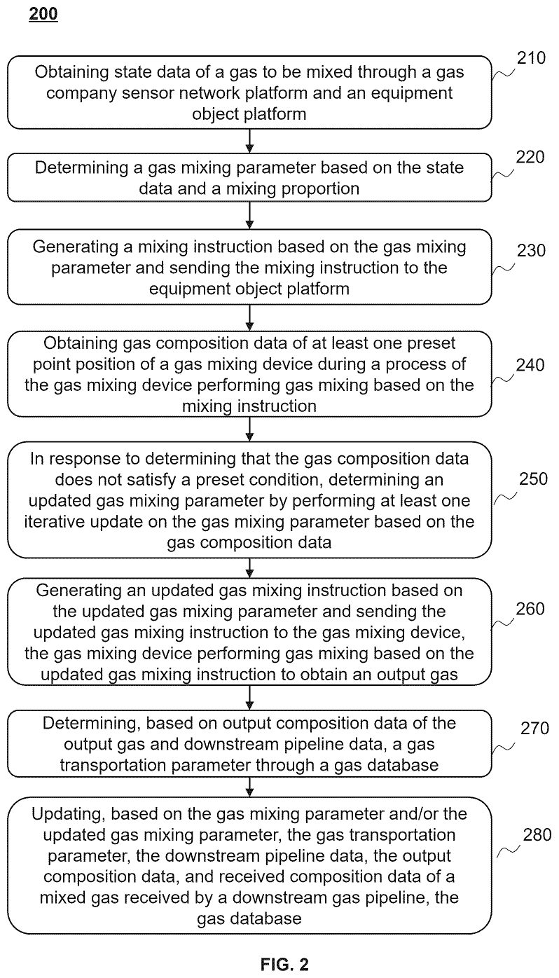

More descriptions may be found in FIGS. 2-4 and the related descriptions thereof.

In some embodiments, the IoT system for gas mixing station equipment monitoring based on smart gas may form a closed loop of information operation among functional platforms to realize the informatization and intelligentization of gas mixing supervision.

FIG. 2 is a flowchart illustrating an exemplary method for gas mixing station equipment monitoring based on smart gas according to some embodiments of the present disclosure. In some embodiments, a process 200 may be implemented by a gas company management platform of an IoT system for gas mixing station equipment monitoring based on smart gas.

More descriptions regarding the platforms of the IoT system for gas mixing station equipment monitoring based on smart gas may be found in FIG. 1 and the related descriptions thereof.

As shown in FIG. 2, the process 200 may include the following operations.

In 210, state data of a gas to be mixed may be obtained through a gas company sensor network platform and an equipment object platform.

The gas to be mixed refers to a gas that needs to be mixed by a gas mixing device. In some embodiments, the gas to be mixed may include at least one of gaseous petroleum gas, hydrogen, or the like.

The state data refers to data related to the state of the gas to be mixed. In some embodiments, one or more sets of state data may be provided, and each set of state data may correspond to one gas to be mixed.

In some embodiments, one set of state data may include at least one of a temperature, a pressure intensity, composition data, or the like, of one gas to be mixed. The composition data refers to data related to the composition of the gas to be mixed.

In some embodiments, the composition data may include at least one of a purity, impurity information, or the like, of the gas to be mixed. The purity refers to an amount of a major component of the gas to be mixed. The impurity information refers to an amount of components other than the major component of the gas to be mixed.

In some embodiments, the gas company management platform may obtain the state data of the gas to be mixed through the gas company sensor network platform and the equipment object platform.

In 220, a gas mixing parameter may be determined based on the state data and a mixing proportion.

The mixing proportion refers to a desired proportion of a plurality of gases to be mixed during mixing. In some embodiments, the mixing proportion may include a volume ratio of the plurality of gases to be mixed. In some embodiments, the mixing proportion of the gas to be mixed may be preset based on industry norms for gas transportation.

The gas mixing parameter refers to an operation parameter of the gas mixing device for gas mixing. In some embodiments, the gas mixing parameter may include at least one of a pressure, a temperature, a flow rate, or the like, during operation of the gas mixing device.

In some embodiments, the gas company management platform may determine the gas mixing parameter based on the state data and the mixing proportion in various ways. For example, the gas company management platform may construct a gas mixing vector based on the state data and the mixing proportion of the gas to be mixed. The gas company management platform may match a same reference gas mixing vector as the gas mixing vector in a gas database, and determine an actual gas mixing parameter in a historical gas mixing record corresponding to the reference gas mixing vector as a current gas mixing parameter. The gas mixing vector refers to a feature vector constructed based on the state data and the mixing proportion of the gas to be mixed. The actual gas mixing parameter refers to a historical gas mixing parameter that is ultimately used by the gas mixing device in the historical gas mixing record.

In some embodiments, the gas company management platform may access the gas database through a government data center.

In some embodiments, the gas company management platform may construct the gas database based on the historical gas mixing record. The gas database may include a plurality of historical gas mixing records and a plurality of vectors corresponding to each of the historical gas mixing records. In some embodiments, the plurality of vectors may include the reference gas mixing vector. The reference gas mixing vector refers to a feature vector constructed based on historical state data and mixing proportion by the gas company management platform.

The historical gas mixing record refers to data related to gas mixing performed by the gas mixing device at a historical time. In some embodiments, the gas company management platform may record the historical state data and mixing proportion, the historical gas mixing parameter, historical output composition data, historical downstream pipeline data, a historical gas transportation parameter, historical received composition data, a historical intermediate gas mixing parameter, and a historical compliance expectation corresponding to gas mixing performed by the gas mixing device at the historical time as one historical gas mixing record, and count the historical gas mixing record in the gas database. More descriptions regarding output composition data, downstream pipeline data, a gas transportation parameter, intermediate gas data, a compliance expectation, and received composition data may be found in the present disclosure below.

In some embodiments, the gas company management platform may determine, based on the state data and the mixing proportion, a preprocessing parameter of the gas to be mixed, and determine the gas mixing parameter based on the mixing proportion and processing state data.

The preprocessing parameter refers to a parameter by which the gas mixing device preprocesses the gas to be mixed before mixing the gas to be mixed. In some embodiments, the preprocessing parameter may include processing the gas to be mixed by heating, pressurizing, or the like. The preprocessing parameter may include a temperature value, a pressure value, or the like, that needs to be increased or decreased.

In some embodiments, the gas company management platform may determine, based on the state data and the mixing proportion, the preprocessing parameter of the gas to be mixed in various ways.

For example, the gas company management platform may determine the preprocessing parameter of the gas to be mixed by the following operations.

S11, a reference state range may be determined based on a historical gas mixing record and/or a mixing proportion.

The reference state range refers to a range of desired state data of the gas to be mixed. The reference state range may include one or more sets of data, each set of data corresponding to the state data of one gas to be mixed. In some embodiments, the reference state range may be preset based on prior experience.

In some embodiments, the gas company management platform may query, based on the state data and the mixing proportion, a historical gas mixing record of which the mixed gas satisfies the mixing proportion during the mixing process from the plurality of historical gas mixing records, and determine a range of the state data corresponding to the historical gas mixing record as the reference state range.

In some embodiments, the gas company management platform may determine reference state ranges of a plurality of gases to be mixed based on the historical gas mixing records. For example, for one of the plurality of gases to be mixed, the gas company management platform may select a historical gas mixing record whose a count of iterations used for determining an updated gas mixing parameter is less than a preset count threshold, and determine a reference state range based on maximum and minimum values of a plurality of historical state data of the historical gas mixing record. The maximum value of the plurality of historical state data may constitute an upper limit of the reference state range, and the minimum value of the plurality of historical state data may constitute a lower limit of the reference state range. The preset count threshold may be preset based on historical experience. More descriptions regarding determining the updated gas mixing parameter may be found in the present disclosure below.

In some embodiments, when the state data of one gas to be mixed is within the corresponding reference state range, the gas company management platform may determine that the gas to be mixed does not require preprocessing and set the preprocessing parameter to null or 0.

S12, a state difference may be determined based on the reference state range.

In some embodiments, when the state data of the gas to be mixed is outside the corresponding reference state range, the gas company management platform may calculate a state difference based on the state data and the reference state range. The state difference refers to a difference between the state data and a central value of the reference state range. The state difference may include one or more sets of data, each set of the one or more sets of data corresponding to one gas to be mixed.

S13, a preprocessing parameter may be determined based on the state difference.

In some embodiments, the gas company management platform may determine the preprocessing parameter based on the state difference. For example, if a state difference in the temperature of the gas to be mixed is −4° C., an adjustment in the temperature of the gas to be mixed is to raise the temperature by 4° C., so as to raise the temperature of the gas to be mixed to the same value as the central value of the reference state range.

The processing state data refers to state data of the gas to be mixed after preprocessing. The processing state data may be obtained through a plurality of composition sensors disposed in the gas mixing station.

In some embodiments, the gas company management platform may determine the gas mixing parameter based on the mixing proportion and the processing state data by vector matching. The process of the gas company management platform for determining the gas mixing parameter based on the mixing proportion and the processing state data may be similar to the process of determining the gas mixing parameter based on the mixing proportion and the state data, which may be found in the process of determining the gas mixing parameter described above.

In some embodiments of the present disclosure, the preprocessing parameter of the gas to be mixed may be determined based on the state data and the mixing proportion of the gas to be mixed, such that the gas to be mixed may be preliminarily processed before mixing, which facilitates the better mixing effect of the gas to be mixed subsequently.

In 230, a mixing instruction may be generated based on the gas mixing parameter, and the mixing instruction may be sent to the equipment object platform.

The mixing instruction refers to a related instruction for instructing the gas mixing device to mix the gas to be mixed. In some embodiments, the gas company management platform may generate the mixing instruction based on the gas mixing parameter and a gas mixing device corresponding to the gas mixing parameter.

In some embodiments, the gas company management platform may generate the mixing instruction based on the gas mixing parameter, and send the mixing instruction to the gas mixing device corresponding to the mixing instruction of the equipment object platform to control the gas mixing device to mix the gas based on the mixing instruction.

In 240, gas composition data of at least one preset point position of a gas mixing device may be obtained during a process of the gas mixing device performing gas mixing based on the mixing instruction.

The gas composition data refers data related to the composition of the mixed gas. In some embodiments, the gas composition data may include an amount of each gas component in the mixed gas.

In some embodiments, the gas composition data may include a plurality of sets of data, and each set of data may correspond to the gas composition data of the at least one preset point position at a sampling time point. The sampling time point may be preset based on historical experience.

The preset point position refers to a point position at which the gas mixing device performs gas sampling. In some embodiments, a plurality of preset point positions may be provided, and the plurality of preset point positions may be preset based on detection needs and/or historical experience.

In some embodiments, the gas composition data may be obtained by a composition detection device disposed on the at least one preset point position of the gas mixing device and uploaded to the equipment object platform. More descriptions regarding the composition detection device may be found in FIG. 1 and the related descriptions thereof.

In 250, in response to determining that the gas composition data does not satisfy a preset condition, an updated gas mixing parameter may be determined by performing at least one iterative update on the gas mixing parameter based on the gas composition data.

The preset condition refers to a condition for determining whether the gas composition data satisfies the mixing proportion. For example, the preset condition may be that composition differences between the gas composition data and theoretical composition data of the plurality of preset point positions are all less than or equal to a preset difference threshold. The theoretical composition data refers to an amount of each gas component in the mixed gas calculated based on the mixing proportion. The composition difference may be expressed by an absolute value of a difference between the gas composition data and the theoretical composition data. The difference between the gas composition data and the theoretical composition data may include a difference between data of each component in the gas composition data and data of the same component in the theoretical composition data. The preset difference threshold may include a plurality of sub-difference thresholds, and each of the sub-difference thresholds may correspond to the data of one component in the composition difference. The preset difference threshold may be determined based on prior experience.

The updated gas mixing parameter refers to a gas mixing parameter obtained after iterative updating.

In some embodiments, in response to determining that the gas composition data does not satisfy the preset condition, the gas company management platform may determine the updated gas mixing parameter based on the gas composition data in various ways. For example, in response to determining that the gas composition data does not satisfy the preset condition, the gas company management platform may determine the updated gas mixing parameter by performing at least one iterative update on the gas mixing parameter based on the gas composition data. The gas composition data not satisfying the preset condition may be that a composition difference between the gas composition data and the theoretical composition data at any one of the plurality of preset point positions is greater than the preset difference threshold.

For example, one of the at least one iterative update may include the following operations.

The gas company management platform may generate, based on the gas mixing parameter and/or an intermediate gas mixing parameter, the mixing instruction, and send the mixing instruction to the gas mixing device to control the gas mixing device to perform the gas mixing based on the mixing instruction. The gas mixing parameter refers to a gas mixing parameter for a first iterative update. The intermediate gas mixing parameter refers to a gas mixing parameter for second and subsequent iterative updates.

In response to determining that intermediate gas data does not satisfy the preset condition, the gas company management platform may adjust, based on the gas mixing parameter or the intermediate gas mixing parameter and a composition difference between the intermediate gas data and the theoretical composition data, the gas mixing parameter and/or the intermediate gas mixing parameter according to a preset rule to determine an intermediate gas mixing parameter for a next iterative update, and perform the next iterative update. The intermediate gas mixing parameter refers to a gas mixing parameter used by the gas mixing device for next gas mixing. The composition difference is a difference between the intermediate gas data and the theoretical composition data. The difference between the intermediate gas data and the theoretical composition data may include a difference between each piece of data in the intermediate gas data and the same piece of data in the theoretical composition data.

The intermediate gas data refers to gas composition data obtained for current gas mixing. In some embodiments, the intermediate gas data may include a plurality of sets of data, each set of data corresponding to intermediate gas data of the at least one preset point position at a sampling time point.

In response to determining that the intermediate gas data does not satisfy the preset condition, the at least one iterative update may be ended, and the gas mixing parameter and/or the intermediate gas mixing parameter may be determined as the updated gas mixing parameter.

In the next iterative update, the gas company management platform may generate the mixing instruction based on the intermediate gas mixing parameter and send the mixing instruction to the gas mixing device to control the gas mixing device to perform the gas mixing based on the mixing instruction, and repeat the above operations until the at least one iterative update is ended, and determine the intermediate gas mixing parameter as the updated gas mixing parameter.

The preset rule refers to a rule for adjusting the gas mixing parameter or the intermediate gas mixing parameter. In some embodiments, the preset rule may include a correspondence between the composition difference and an adjustment parameter. The adjustment parameter may include an adjustment direction, an adjustment magnitude, or the like, of the state data of the gas to be mixed.

In some embodiments, the gas company management platform may determine the preset rule based on the historical gas mixing records. For example, the gas company management platform may construct the preset rule based on a gas mixing parameter before a plurality of historical iterative updates and an intermediate gas mixing parameter after the plurality of historical iterative updates in the historical gas mixing records, and a composition difference after the gas mixing device performs the gas mixing based on an updated intermediate gas mixing parameter. For example, if the temperature in the gas mixing parameter before updating is 20° C., the temperature in the intermediate gas mixing parameter after updating is 24° C., and the composition difference between the intermediate gas data and the theoretical composition data is changed from −5 L/mol before updating to 0, it is determined that the adjustment direction corresponding to the composition difference is to raising the temperature by 4° C.

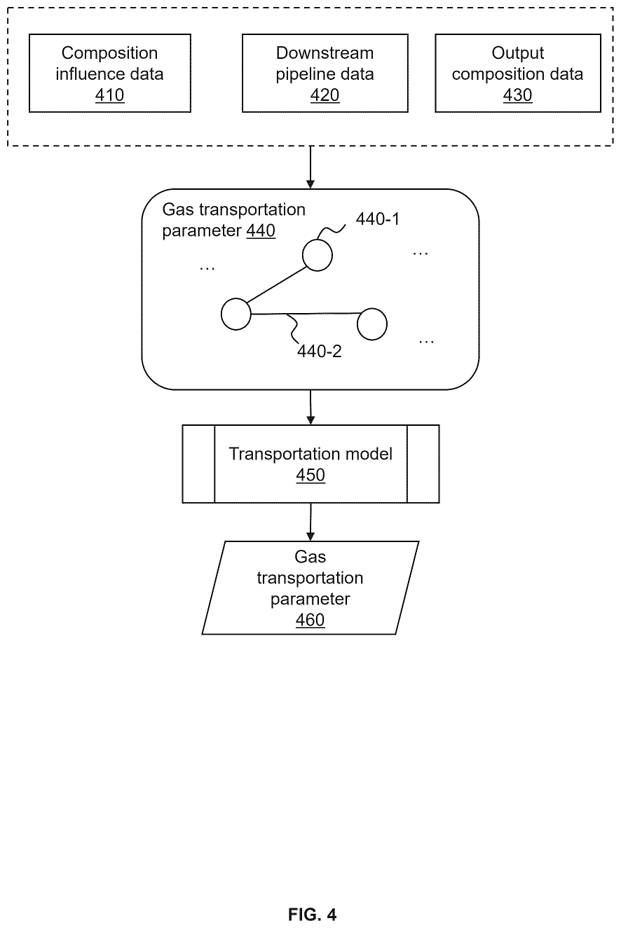

In some embodiments, the gas company management platform may determine the intermediate gas mixing parameter for the next iterative update through a gas mixing model. More descriptions may be found in FIG. 4 and the related descriptions thereof.

In 260, an updated gas mixing instruction may be generated based on the updated gas mixing parameter, and the updated gas mixing instruction may be sent to the gas mixing device, the gas mixing device performing gas mixing based on the updated gas mixing instruction to obtain an output gas.

In some embodiments, if the gas composition data consistently satisfies the preset condition, the gas company management platform may generate the mixing instruction based on the gas mixing parameter and send the mixing instruction to the gas mixing device, and the gas mixing device may perform the gas mixing based on the mixing instruction to obtain the output gas.

The updated gas mixing instruction refers to a mixing instruction updated based on the updated gas mixing parameter. In some embodiments, the gas company management platform may generate the updated gas mixing instruction based on the updated gas mixing parameter, send the updated gas mixing instruction to the corresponding gas mixing device in the equipment object platform, and the gas mixing device may perform the gas mixing based on the updated gas mixing instruction to obtain the output gas.

The output gas refers to a gas output from the gas mixing station after the mixing of the gas to be mixed is completed.

In 270, a gas transportation parameter may be determined based on output composition data of the output gas and downstream pipeline data through a gas database.

The output composition data refers to composition data of the output gas. In some embodiments, the output composition data may include an amount of each gas component in the output gas. In some embodiments, the output composition data may be obtained by a composition detection device disposed at a gas outlet of the gas mixing station and uploaded to the equipment object platform.

The received composition data refers to composition data of the output gas received by a downstream gas pipeline. In some embodiments, the received composition data may include an amount of each gas component in the output gas received by the downstream gas pipeline.

In some embodiments, the received composition data may be obtained by a composition detection device disposed in the downstream gas pipeline and uploaded to the equipment object platform.

The downstream pipeline data refers to data related to the downstream gas pipelines. In some embodiments, the downstream pipeline data may include at least one of a length, a change in an internal diameter, a pipeline structure, a cleanliness degree, or the like, of the downstream gas pipeline. The change in the internal diameter refers to a change in the internal diameter of the downstream gas pipeline at different positions. The pipeline structure refers to a structure of the downstream gas pipeline, such as a shape, a turn, a branch, or the like, of the downstream gas pipeline. The cleanliness degree may be expressed, for example, by a count of impurities.

In some embodiments, the downstream pipeline data may include one or more sets of data, each set of data corresponding to a segment of the downstream gas pipeline.

In some embodiments, the downstream pipeline data may be uploaded to the gas company management platform by a gas company.

The gas transportation parameter refers to a parameter related to the delivery of the output gas to a plurality of downstream gas pipelines. In some embodiments, the gas transportation parameter may include at least one of parameters such as a pressure, a flow rate, and a flow velocity of the output gas delivered to the plurality of downstream gas pipelines by the gas mixing station. The downstream gas pipeline refers to a gas pipeline through which the gas mixing station transports the output gas to a destination. The destination may include a downstream station, etc. More descriptions regarding the downstream station may be found in FIG. 4 and the related descriptions thereof.

In some embodiments, the gas company management platform may determine the gas transportation parameter based on the output composition data and the downstream pipeline data in various ways. For example, the gas company management platform may construct a transportation vector based on the output composition data and the downstream pipeline data, and match a reference transportation vector that satisfies a first matching condition in the gas database. The gas company management platform may extract historical output composition data and historical received composition data corresponding to the reference transportation vector, take a reference transportation vector with the smallest difference between the historical output composition data and the historical received composition data as a target vector, and take a historical gas transportation parameter corresponding to the target vector as a current gas transportation parameter. The transportation vector is a feature vector constructed based on the output composition data and the downstream pipeline data. More descriptions regarding the received composition data may be found in operation 280 and the related descriptions thereof.

The difference between the historical output composition data and the historical received composition data may include a difference between each piece of data in the historical output composition data and the same piece of data in the historical received composition data. It is understood that the smaller the difference between the historical output composition data and the historical received composition data, the more uniformly the mixed gas during transportation, and the more reasonable the corresponding gas transportation parameter.

The first matching condition may include a similarity exceeding a first similarity threshold. The similarity of the vector is negatively correlated with a vector distance. The vector distance may include, for example, a Euclidean distance, etc. The first similarity threshold may be preset based on historical experience.

In some embodiments, a plurality of vectors in the gas database corresponding to the historical gas mixing records may include a reference transportation vector. The gas company management platform may construct the reference transportation vector based on the historical output composition data and the historical downstream pipeline data in the historical gas mixing records. The reference transportation vector refers to a feature vector constructed based on the historical output composition data and the historical downstream pipeline data. More descriptions regarding the gas database may be found in the operation 220 and the related descriptions thereof.

In some embodiments, the gas company management platform may determine composition influence data through the gas database based on the output composition data and the downstream pipeline data; and determine the gas transportation parameter based on the composition influence data and the output composition data.

The composition influence data refers to data featuring the impact of the downstream gas pipeline on the composition of the output gas after the gas mixing station transports the output gas based on the gas transportation parameter. The greater the composition influence data, the greater the impact of the downstream gas pipeline on the composition of the output gas.

In some embodiments, the composition influence data may include one or more sets of data, each set of data corresponding to one gas transportation parameter.

In some embodiments, the gas company management platform may determine the composition influence data based on the output composition data and the downstream pipeline data in various ways. For example, the gas company management platform may query, based on the output composition data and the downstream pipeline data, historical output composition data and historical downstream pipeline data that are the same as the output composition data and the downstream pipeline data in the gas database, and determine historical composition influence data corresponding to the historical output composition data and the historical downstream pipeline data as current composition influence data.

In some embodiments, the gas company management platform may determine a downstream pipeline feature based on the downstream pipeline data, and determine the composition influence data based on the downstream pipeline feature and the output composition data through the gas database.

The downstream pipeline feature refers to data for characterizing a structural condition of a downstream pipeline. In some embodiments, the downstream pipeline feature may include at least one of a length of a pipeline of a different inner diameter in the downstream gas pipeline, a count of branches and a count of turns in the downstream gas pipeline, etc.

In some embodiments, the gas company management platform may statistically obtain the downstream pipeline feature based on the downstream pipeline data of the historical gas mixing records in the gas database.

In some embodiments, the gas company management platform may construct an influence vector based on the downstream pipeline feature and the output composition data, match a plurality of reference influence vectors that satisfy a second matching condition in the gas database, and determine the historical composition influence data and the historical gas transportation parameters in the historical gas mixing record corresponding to each of the plurality of reference influence vectors as a set of composition influence data. The influence vector is a feature vector constructed based on the downstream pipeline feature and the output composition data. The second matching condition may include a similarity exceeding a second similarity threshold. The second similarity threshold may be preset based on historical experience. The historical composition influence data may be represented by a difference between the historical output composition data and the historical received composition data. More descriptions regarding the difference between the historical output composition data and the historical received composition data may be found in the operation 270 and the related descriptions thereof.

In some embodiments, a plurality of vectors in the gas database corresponding to the historical gas mixing records may include a reference influence vector. The gas company management platform may construct the reference influence vector based on the historical downstream pipeline feature and the historical output composition data in the historical gas mixing records. The reference influence vector is a feature vector constructed based on the historical downstream pipeline feature and the historical output composition data. More descriptions regarding the gas database may be found in the operation 220 and the related descriptions thereof.

In some embodiments of the present disclosure, the vectors are constructed based on the downstream pipeline feature and the output composition data and the composition influence data is determined through the gas database, such that the difficulty of searching the composition influence data corresponding to the downstream gas pipeline in the gas database caused by the downstream pipeline data is too complicated can be avoided, and the composition impact data can be determined more quickly.

In some embodiments, for each downstream gas pipeline in the downstream pipeline data, the gas company management platform may calculate, based on the plurality sets of composition influence data corresponding to the downstream gas pipeline, the difference between the composition influence data and a theoretical difference, and determine a gas transportation parameter with the smallest difference as the current gas transportation parameter. One set of composition influence data may correspond to one gas transportation parameter.

The theoretical difference may characterize a difference degree the output composition data and the theoretical composition data. In some embodiments, the gas company management platform may determine a difference between the output composition data and the theoretical composition data as the theoretical difference. The difference between the output composition data and the theoretical composition data may include a difference between each piece of data in the output composition data and the same piece of data in the theoretical composition data.

In some embodiments, the gas company management platform may determine the gas transportation parameter through a transportation model. More descriptions regarding the gas transportation parameter may be found in FIG. 4 and the related descriptions.

In some embodiments of the present disclosure, by considering the effect of the downstream gas pipeline on the composition of the output gas when the gas is transported under different gas transportation parameters, a more reasonable gas transportation parameter can be determined, and the composition stability of the output gas during the transportation can be guaranteed.

In 280, the gas database may be updated based on the gas mixing parameter and/or the updated gas mixing parameter, the gas transportation parameter, the downstream pipeline data, the output composition data, and received composition data of a mixed gas received by a downstream gas pipeline.

In some embodiments, the gas company management platform may record the gas mixing parameter and/or the updated gas mixing parameter of the current gas mixing, the gas transportation parameter, the downstream pipeline data, the output composition data, and the received composition data of the mixed gas received by the downstream gas pipeline as a set of historical gas mixing records to be stored in the gas database. The gas database may be continually updated by storing the historical gas mixing records for each gas mixing at the plurality of gas mixing stations to the gas database.

It is understood that storing mixed gas data from different gas mixing stations in the gas database expands the data volume of reference data when determining the gas transportation parameter, thereby obtaining a more reasonable gas transportation parameter.

In some embodiments, by monitoring the compositional change of the mixed gas in time during the mixing process, the updated gas mixing parameter is continuously and iteratively updated to ensure that the mixed gas maintains relatively unifrom during mixing, making the mixed gas achieve better mixing effect. By considering the transportation of the output gas in the downstream gas pipeline and the actual situation of the downstream gas pipeline, a more reasonable gas transportation parameter can be determined, and the output gas maintains relatively uniform in the downstream gas pipeline.

It should be noted that the foregoing description of the process 200 is intended to be exemplary and illustrative only and does not limit the scope of application of the present disclosure. For those skilled in the art, various corrections and changes to the process 200 may be made under the guidance of the present disclosure. However, these corrections and changes remain within the scope of the present disclosure.

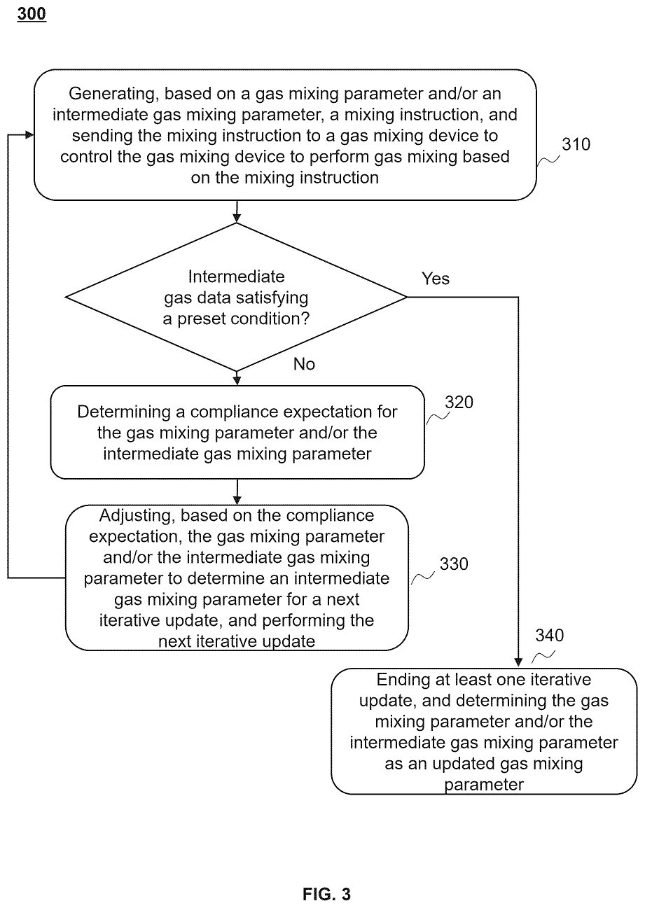

FIG. 3 is a flowchart illustrating a process of determining an updated gas mixing parameter according to some embodiments of the present disclosure.

In some embodiments, for one of at least one iterative update: a gas company management platform may generate, based on a gas mixing parameter and/or an intermediate gas mixing parameter, a mixing instruction, and send the mixing instruction to a gas mixing device to control the gas mixing device to perform gas mixing based on the mixing instruction; in response to determining that intermediate gas data does not satisfy a preset condition, determine a compliance expectation for the gas mixing parameter and/or the intermediate gas mixing parameter; adjust, based on the compliance expectation, the gas mixing parameter and/or the intermediate gas mixing parameter to determine an intermediate gas mixing parameter for a next iterative update, and perform the next iterative update; and in response to determining that the intermediate gas data satisfies the preset condition, end the at least one iterative update, and determine the gas mixing parameter and/or the intermediate gas mixing parameter as the updated gas mixing parameter. More descriptions regarding the intermediate gas mixing parameter, the intermediate gas data, and the preset condition may be found in FIG. 2 and the related descriptions thereof.

As shown in FIG. 3, a process 300 may include the following operations.

In 310, a mixing instruction may be generated based on a gas mixing parameter and/or an intermediate gas mixing parameter, and the mixing instruction may be sent to a gas mixing device to control the gas mixing device to perform gas mixing based on the mixing instruction. More descriptions may be found in FIG. 2 and the related descriptions thereof.

In some embodiments, in response to determining that the intermediate gas data does not satisfy the preset condition, operation 320 may be performed, and in response to determining that the intermediate gas data satisfies the preset condition, operation 340 may be performed.

In 320, a compliance expectation for the gas mixing parameter and/or the intermediate gas mixing parameter may be determined.

The compliance expectation refers to a condition required for the intermediate gas data to satisfy the preset condition under the gas mixing parameter and/or the intermediate gas mixing parameter when the gas mixing device does not other operations. In some embodiments, the compliance expectation may include a duration required for the intermediate gas data to satisfy the preset condition.

It is understood that, due to the random movement of gas molecules, the uniformity of the mixed gas gradually changes over time, and a certain period of time is needed for continuing gas mixing to ensure that the intermediate gas data in a first iterative update satisfies the preset condition, or the gas mixing parameter needs to be iteratively updated to obtain the intermediate gas mixing parameter to ensure that the intermediate gas data in the next iterative update satisfies the preset condition.

In some embodiments, in response to determining that the intermediate gas data does not satisfy the preset condition, the gas company management platform may determine the compliance expectation for the gas mixing parameter and/or the intermediate gas mixing parameter in various ways. For example, the gas company management platform may determine a historical compliance expectation as a current compliance expectation by selecting the same historical intermediate gas data as the intermediate gas data and the corresponding historical compliance expectation in the gas database.

In some embodiments, in response to determining that the intermediate gas data does not satisfy the preset condition, the gas company management platform may determine the compliance expectation based on a change trend of the intermediate gas data.

The change trend refers to a change trend of the intermediate gas data over time. In some embodiments, the change trend may include a change trend of the intermediate gas data at a plurality of preset point positions in the gas mixing device over time. The change trend of the intermediate gas data at each of the plurality of preset point positions may be represented by curve fitting, etc.

In some embodiments, for each of the plurality of preset point positions, the gas company management platform may obtain a fitting curve by performing curve fitting based on the intermediate gas data at a plurality of sampling time points. A horizontal axis of the fitting curve represents time, and a vertical axis of the fitting curve represents the intermediate gas data. The plurality of sampling time points refer to time points within a time period in which the gas mixing device performs the mixing instruction or an updated gas mixing instruction.

It is understood that since the intermediate gas data obtained by each iterative update is different, each iterative update needs to re-determine the change trend.

In some embodiments, for the fitting curve corresponding to each of the plurality of preset point positions, the gas company management platform may calculate a difference between time at which the intermediate gas data satisfies the preset condition and the current time, determine the difference as the compliance expectation corresponding to the point position, and determine a maximum value of the compliance expectations corresponding to all the preset point positions as the compliance expectation for the gas mixing parameter or the intermediate gas mixing parameter.

In some embodiments, by analyzing the change trend of the intermediate gas data, the accuracy of determining the compliance expectation can be improved, which in turn facilitates a more efficient intermediate gas mixing parameter, and improves the efficiency of gas mixing.

In 330, the gas mixing parameter and/or the intermediate gas mixing parameter may be adjusted based on the compliance expectation to determine an intermediate gas mixing parameter for a next iterative update, and the next iterative update may be performed.

In some embodiments, the gas company management platform may adjust the gas mixing parameter based on the compliance expectation of the gas mixing parameter in the first iterative update to obtain the intermediate gas mixing parameter and adjust the intermediate gas mixing parameter based on the compliance expectation of the intermediate gas mixing parameter in the next iterative update obtain the intermediate gas mixing parameter for the next iterative update.

In some embodiments, the gas company management platform may adjust the gas mixing parameter or the intermediate gas mixing parameter based on the compliance expectation for the gas mixing parameter or the intermediate gas mixing parameter in various ways. For example, the management platform may select, based on the compliance expectation, a historical compliance expectation in the gas database that is the same as a current compliance expectation, and determine a historical intermediate gas mixing parameter obtained by adjusting a historical gas mixing parameter or the historical intermediate gas mixing parameter based on the historical compliance expectation as the intermediate gas mixing parameter for the next iterative update.

In some embodiments, the gas company management platform may determine, based on the compliance expectation, the gas mixing parameter and/or the intermediate gas mixing parameter, processing state data, and a transportation saturation, the intermediate gas mixing parameter for the next iterative update through a gas mixing model. More descriptions regarding the processing state data may be found in FIG. 2 and the descriptions thereof.

The gas mixing model refers to a model used to determine the intermediate gas mixing parameter. In some embodiments, the gas mixing model may be a machine learning model. For example, the gas mixing model may include any one of a convolutional neural networks (CNN) model, a neural networks (NN) model, or other customized model structure, or the like, or any combination thereof.

The transportation saturation is used to characterize a satisfaction of the gas output from a downstream station to a preset gas usage condition. The preset gas usage condition is used to characterize a gas usage demand of users for the gas supplied from the downstream station. In some embodiments, the preset gas usage condition may include the transportation saturation that does not affect the gas usage of the users. The preset gas usage condition may be set in advance based on historical experience. More descriptions regarding the downstream station may be found in FIG. 4 and the related descriptions thereof.

In some embodiments, the gas company management platform may obtain a gas pressure of the gas in the gas pipeline output from the downstream station through an equipment object platform, and determine a ratio of the gas pressure to a standard gas pressure as the transportation saturation of the downstream station. The standard gas pressure may be preset based on gas transportation regulations.

It is understood that when the gas pressure is lower than the standard gas pressure, it indicates that the gas supplied by the downstream station is relatively low and does not satisfy the gas usage demand of the users.

In some embodiments, the gas company management platform may train the gas mixing model based on a large amount of first training samples with first labels through gradient descent, etc. The first training samples may include a sample compliance expectation, a sample gas mixing parameter or a sample intermediate gas mixing parameter, sample processing state data, a sample transportation saturation, and the first label of the first training sample may include a historical updated gas mixing parameter.

In some embodiments, the gas company management platform may determine the first training samples and the first labels based on the historical gas mixing records. For example, the gas company management platform may select a historical gas mixing record of which the historical output composition data satisfies the preset condition, use a historical compliance expectation, a historical gas mixing parameter or a historical intermediate gas mixing parameter, historical processing state data, and a historical transportation saturation in the historical gas mixing record as the first training samples, and determine the historical updated gas mixing parameter in the historical gas mixing record as the first label.

In some embodiments, the gas mixing model may be trained by inputting the plurality of first training samples with the first labels into an initial gas mixing model, constructing a loss function from the training labels and prediction results of the initial gas mixing model, iteratively updating the initial gas mixing model based on the loss function, and completing the training of the gas mixing model when the loss function of the initial gas mixing model satisfies a preset iteration condition. The preset iteration conditions may be that the loss function converges, a count of iterations reaches a set value, etc.

In some embodiments of the present disclosure, by introducing the gas mixing model, patterns can be found from a large volume of data based on the self-learning capability of the machine learning model, thereby improving the accuracy and efficiency of determining the intermediate gas mixing parameter.

In 340, at least one iterative update may be ended, and the gas mixing parameter and/or the intermediate gas mixing parameter may be determined as an updated gas mixing parameter. More descriptions may be found in the operation 250 and the related descriptions thereof.

In some embodiments of the present disclosure, the updated gas mixing parameter is determined through a plurality of iterative updates, which ensures the uniformity of the mixed gas throughout the mixing process, and thus obtains the output gas that is closer to the ideal mixing proportion.

It should be noted that the foregoing description of the process 300 is intended to be exemplary and illustrative only and does not limit the scope of application of the present disclosure. For those skilled in the art, various corrections and changes to the process 300 may be made under the guidance of the present disclosure. However, these corrections and changes remain within the scope of the present disclosure.

FIG. 4 is a schematic diagram illustrating an exemplary transportation model according to some embodiments of the present disclosure.

In some embodiments, a gas company management platform may construct a gas transportation map 440 based on composition influence data 410, downstream pipeline data 420, and output composition data 430; and determine a gas transportation parameter 460 based on the gas transportation map 440 through a transportation model 450. More descriptions regarding the composition influence data, the downstream pipeline data, the output composition data, and the gas transportation parameter may be found in FIG. 2 and FIG. 3 and the related descriptions thereof.

The gas transportation map 440 refers to a graph structure that characterizes a correlation between a gas mixing station and a downstream station. The graph structure is a data structure comprising nodes and edges, where edges connect nodes, and the nodes and the edges may have features. In some embodiments, the gas transportation map may be a directed graph. A starting point of the directed graph may be a current mixing station node, and a direction of the edges may be a transportation direction of gas.

In some embodiments, the gas company management platform may construct the gas transportation map based on a connection relationship between the gas mixing station and the downstream station in a gas pipeline network. The nodes (e.g., a node 440-1) of the gas transportation map may include a gas mixing station node, a pipeline key node, and a downstream station node. The downstream station refers to a gas station that receives a mixed gas output from the gas mixing station. For example, the downstream station includes a gas regulating station.

The pipeline key node refers to a node indicating a key position in a gas pipeline. In some embodiments, the gas company management platform may obtain historical composition data of a plurality of positions in the gas pipeline through a government data center, determine, based on the historical composition data, a composition change of the gas between two neighboring positions, and determine a key position based on the composition change. The plurality of positions may include a turning point, a branch point, and a confluence point of the gas pipeline or the gas pipeline, etc. The historical composition data for each position may be obtained by a composition detection device deployed at each position. The historical composition data refers to received composition data acquired at a historical time. More descriptions regarding the received composition data may be found in FIG. 4 and the related descriptions thereof.

In some embodiments, for the two neighboring positions, the gas company management platform may calculate a difference between the historical composition data of an upstream position and historical composition data of a downstream position, and use the difference as the composition change of the gas between the two neighboring positions. The difference in the historical composition data of the two positions may include a difference in each piece of the historical composition data of the two positions.

In some embodiments, if the composition change of the gas between the two neighboring positions exceeds a change threshold, the gas company management platform may determine the two neighboring positions as key nodes.

Node features of the gas mixing station node may include the output composition data.

Node features of the downstream station node may include a station scale. The station scale of the downstream station may be expressed by data such as an amount of gas that may be received per day.

Different types of pipeline key nodes have different node features. For example, the node features of a node representing a turning point of the gas pipeline may include, for example, a type and size of a turning fitting. As another example, the node features of a node representing a branch point of the gas pipeline may include a count of branches, an inner diameter of a pipeline before and after the branch, etc.

In some embodiments, the node features of the downstream station node may further include a branch gas mixing parameter and a branch transportation parameter of other gas mixing stations corresponding to the downstream station. The other gas mixing stations corresponding to the downstream station refer to gas mixing station that supply the mixed gas to the downstream station other than the current gas mixing station.

The branch gas mixing parameter refers to a gas mixing parameter used as a basis for the other mixing stations performing a gas mixing operation. The branch transportation parameter refers to a gas transportation parameter used as a basis for the other mixing stations transporting the mixed gas.

In some embodiments, the gas company management platform may obtain the branch gas mixing parameter and the branch transportation parameter of the other gas mixing stations through the government data center.

In some embodiments of the present disclosure, the branch gas mixing parameter and the branch transportation parameter of the other gas mixing stations are added in the node features of the downstream station node, which provides a reference in determining the gas transportation parameter, thereby improving the accuracy of determining the gas transportation parameter.

The edges of the gas transportation map characterize connectivity between the nodes. In some embodiments, the edges (e.g., an edge 440-2) of the gas transportation map may include gas pipelines connected between the nodes. Edge feature may include composition influence data of the gas pipeline, etc.

In some embodiments, the gas company management platform may input the gas transportation map into the transportation model to obtain the gas transportation parameter output by the transportation model.

The transportation model refers to a model for determining the gas transportation parameter. In some embodiments, the transportation model may be a machine learning model. For example, the transportation model may include any one of a graph neural network (GNN) model, or other customized model structures, or the like, or any combination thereof. An edge output of the transportation model may correspond to the gas transportation parameter of the gas pipeline.

In some embodiments, the gas company management platform may train the transportation model based on a training sample set through gradient descent, etc. The training sample set may include a large amount of second training samples with second labels. The second training samples may include a sample gas transportation map, and the second label of the second training sample may be an actual gas transportation parameter.

In some embodiments, the gas company management platform may determine the second training samples and the second labels based on historical gas mixing records. For example, the gas company management platform may select a historical gas mixing record in which each piece of historical composition influence data is greater than a preset composition threshold, and construct the sample gas transportation map based on the historical composition influence data, historical downstream pipeline data, and historical output composition data in the historical gas mixing record, and use an actual gas transportation parameter of each gas pipeline in the sample gas transportation map as the second label of the sample gas transportation map. The preset composition threshold may include a plurality of sub-composition thresholds. Each of the plurality of sub-composition thresholds may correspond to one piece of the historical composition influence data. The preset composition threshold may be determined based on prior experience.

In some embodiments, the training process of the transportation model may be similar to the training process of the gas mixing model, which may be implemented as described in the training process of the gas mixing model.

In some embodiments, in response to determining that a transportation saturation of the downstream station does not satisfy a preset gas usage condition, the gas company management platform may determine, based on station data of the downstream station, a target training sample from the training sample set; and adjust a learning rate of the target training sample, and perform reinforcement training on the transportation model of a gas mixing station corresponding to the downstream station based on an adjusted learning rate. Each gas mixing station may correspond to one transportation model. More descriptions regarding the transportation saturation and the preset gas usage condition may be found in FIG. 3 and the related descriptions thereof.

The station data refers to data correlated with the downstream station. In some embodiments, the station data may include, for example, the station scale of the downstream station and a count of gas mixing stations connected. More descriptions regarding the station scale may be found in the present disclosure above.

The target training sample refers to a second training sample that is more applicable to the downstream station. In some embodiments, the gas company management platform may select, based on the station data of the downstream station, a sample gas transportation map in the training sample set in which a station difference satisfies a preset difference condition, and determine the sample gas transportation map in which the transportation saturation of the downstream station satisfies the preset gas usage condition as the target training sample. The station difference satisfying the preset difference condition may include the station difference being less than a preset station threshold. The preset station threshold may be preset based on historical experience.

The station difference characterizes a difference between the station data and sample station data. The sample station data refers to station data of the downstream station in the sample gas transportation map. In some embodiments, the gas company management platform may determine a difference between the station data and the sample station data as the station difference.

In some embodiments, the gas company management platform may adjust the learning rate of the target training sample, for example, by setting a higher learning rate for target training data. The gas company management platform may perform reinforcement training on the transportation model of the gas mixing station corresponding to the downstream station based on the adjusted learning rate and the target training sample, and re-determine, through the transportation model after the reinforcement training, the gas transportation parameters for each gas mixing station.

It is understood that during the use of the transportation model, there may be other downstream stations whose transportation saturation does not satisfy the preset gas usage condition, which requires the reinforcement training of the transportation model, resulting in different model parameters of the transportation model. Accordingly, the reinforcement training needs to be performed on the transportation parameter of each gas mixing station.

In some embodiments, in response to determining that the transportation saturation of the downstream station does not satisfy the preset gas usage condition, the transportation model of each gas station is re-trained using the target training sample such that the transportation model can determine a more appropriate gas transportation parameter, thereby improving the transportation saturation of the downstream station.

In some embodiments of the present disclosure, the construction of the gas transportation map allows for the effective organization of scattered and huge amounts of data and the characteristics thereof, and the use of the transportation model allows for better capturing of topological and relational information in the gas transportation map, thereby improving the accuracy of determining the gas transportation parameter.

Some embodiments of the present disclosure further provide a non-transitory computer-readable storage medium, comprising one or more sets of computer instructions that, when read by a computer, may direct the computer to implement the method described in any of the above embodiments.

In addition, certain features, structures, or characteristics of one or more embodiments of the present disclosure may be suitably combined.

It should be noted that if there is any inconsistency or conflict between the description, definition, and/or use of terms in the auxiliary materials of the present disclosure and the content of the present disclosure, the description, definition, and/or use of terms in the present disclosure is subject to the present disclosure.

1. A method for gas mixing station equipment monitoring based on smart gas, implemented by a gas company management platform of an Internet of Things (IoT) system for gas mixing station equipment monitoring based on smart gas, comprising:
obtaining state data of a gas to be mixed through a gas company sensor network platform and an equipment object platform, the equipment object platform including a state monitoring device configured to collect the state data of the gas to be mixed and a gas mixing device;
determining a gas mixing parameter based on the state data and a mixing proportion, the mixing proportion referring to a desired proportion of a plurality of gases to be mixed during mixing, and the gas mixing parameter referring to an operation parameter of the gas mixing device for gas mixing;
generating a mixing instruction based on the gas mixing parameter and sending the mixing instruction to the equipment object platform;
obtaining gas composition data of at least one preset point position of the gas mixing device during a process of the gas mixing device performing gas mixing based on the mixing instruction;
in response to determining that the gas composition data does not satisfy a preset condition, determining an updated gas mixing parameter by performing at least one iterative update on the gas mixing parameter based on the gas composition data, the preset condition referring to a condition for determining whether the gas composition data satisfies the mixing proportion;
generating an updated gas mixing instruction based on the updated gas mixing parameter and sending the updated gas mixing instruction to the gas mixing device, the gas mixing device performing gas mixing based on the updated gas mixing instruction to obtain an output gas;
determining, based on output composition data of the output gas and downstream pipeline data, a gas transportation parameter through a gas database, the gas database being configured in a government data center; and
updating, based on the gas mixing parameter and/or the updated gas mixing parameter, the gas transportation parameter, the downstream pipeline data, the output composition data, and received composition data of a mixed gas received by a downstream gas pipeline, the gas database.

2. The method of claim 1, wherein the determining a gas mixing parameter based on the state data and a mixing proportion includes:
determining, based on the state data and the mixing proportion, a preprocessing parameter of the gas to be mixed; and
determining, based on the mixing proportion and processing state data, the gas mixing parameter, the processing state data being state data obtained by preprocessing the gas to be mixed based on the preprocessing parameter through the equipment object platform.

3. The method of claim 1, wherein the in response to determining that the gas composition data does not satisfy a preset condition, determining an updated gas mixing parameter by performing at least one iterative update on the gas mixing parameter based on the gas composition data includes:
for one of the at least one iterative update:
generating, based on the gas mixing parameter and/or an intermediate gas mixing parameter, the mixing instruction, and sending the mixing instruction to the gas mixing device to control the gas mixing device to perform gas mixing based on the mixing instruction, wherein the gas mixing parameter refers to a gas mixing parameter for a first iterative update, the intermediate gas mixing parameter refers to a gas mixing parameter for second and subsequent iterative updates, and the intermediate gas mixing parameter refers to a gas mixing parameter used by the gas mixing device for next gas mixing;
in response to determining that intermediate gas data does not satisfy the preset condition, determining a compliance expectation for the gas mixing parameter and/or the intermediate gas mixing parameter, the intermediate gas data being gas composition data obtained for the current gas mixing, and the compliance expectation including a duration required for the intermediate gas data to satisfy the preset condition;
adjusting, based on the compliance expectation, the gas mixing parameter and/or the intermediate gas mixing parameter to determine an intermediate gas mixing parameter for a next iterative update, and performing the next iterative update; and
in response to determining that the intermediate gas data satisfies the preset condition, ending the at least one iterative update, and determining the gas mixing parameter and/or the intermediate gas mixing parameter as the updated gas mixing parameter.

4-5. (canceled)

6. The method of claim 1, wherein the determining, based on output composition data of the output gas and downstream pipeline data, a gas transportation parameter through a gas database includes:
determining, based on the output composition data and the downstream pipeline data, composition influence data through the gas database, the composition influence data referring to data featuring the impact of the downstream gas pipeline on the composition of the output gas after the gas mixing station transports the output gas based on the gas transportation parameter; and
determining, based on the composition influence data and the output composition data, the gas transportation parameter, the gas transportation parameter referring to a parameter related to the delivery of the output gas to a plurality of downstream gas pipelines.

7. (canceled)

8. The method of claim 6, wherein the determining, based on the composition influence data and the output composition data, the gas transportation parameter includes:
constructing, based on the composition influence data, the downstream pipeline data, and the output composition data, a gas transportation map, the gas transportation map referring to a graph structure that characterizes a correlation between a gas mixing station and a downstream station; and
determining, based on the gas transportation map, the gas transportation parameter through a transportation model, the transportation model being a machine learning model.

9-10. (canceled)

11. An Internet of Things (IoT) system for gas mixing station equipment monitoring based on smart gas, comprising a government safety supervision management platform, a government safety supervision sensor network platform, a government safety supervision object platform, a gas company sensor network platform, and an equipment object platform, wherein the government safety supervision management platform includes a government data center, the government safety supervision object platform includes a gas company management platform, the government safety supervision management platform refers to a comprehensive management platform for government information management, the government safety supervision sensor network platform refers to a platform for comprehensive management of government sensor information, the government safety supervision object platform refers to a platform for government supervision information generation and control information execution, the gas company sensor network platform refers to a platform for comprehensive management of sensor information of a gas company, the equipment object platform refers to a functional platform for perceptual information generation and control information execution, the government data center refers to a data center for storing data of the IoT system and the gas company management platform refers to a comprehensive management platform for gas company information; the gas company management platform is configured to:
obtain state data of a gas to be mixed through the gas company sensor network platform and the equipment object platform, the equipment object platform including a state monitoring device configured to collect the state data of the gas to be mixed and a gas mixing device;
determine a gas mixing parameter based on the state data and a mixing proportion, the mixing proportion referring to a desired proportion of a plurality of gases to be mixed during mixing, and the gas mixing parameter referring to an operation parameter of the gas mixing device for gas mixing;
generate a mixing instruction based on the gas mixing parameter and send the mixing instruction to the equipment object platform;
obtain gas composition data of at least one preset point position of the gas mixing device during a process of the gas mixing device performing gas mixing based on the mixing instruction;
in response to determining that the gas composition data does not satisfy a preset condition, determine an updated gas mixing parameter by performing at least one iterative update on the gas mixing parameter based on the gas composition data, the preset condition referring to a condition for determining whether the gas composition data satisfies the mixing proportion;
generate an updated gas mixing instruction based on the updated gas mixing parameter and send the updated gas mixing instruction to the gas mixing device, the gas mixing device performing gas mixing based on the updated gas mixing instruction to obtain an output gas;
determine, based on output composition data of the output gas and downstream pipeline data, a gas transportation parameter through a gas database, the gas database being configured in the government data center; and
update, based on the gas mixing parameter and/or the updated gas mixing parameter, the gas transportation parameter, the downstream pipeline data, the output composition data, and received composition data of a mixed gas received by a downstream gas pipeline, the gas database.

12. The IoT system of claim 11, wherein the gas company management platform is further configured to:
determine, based on the state data and the mixing proportion, a preprocessing parameter of the gas to be mixed; and
determine, based on the mixing proportion and processing state data, the gas mixing parameter, the processing state data being state data obtained by preprocessing the gas to be mixed based on the preprocessing parameter through the equipment object platform.

13. The IoT system of claim 11, wherein the gas company management platform is further configured to:
for one of the at least one iterative update:
generate, based on the gas mixing parameter and/or an intermediate gas mixing parameter, the mixing instruction, and send the mixing instruction to the gas mixing device to control the gas mixing device to perform gas mixing based on the mixing instruction, wherein the gas mixing parameter refers to a gas mixing parameter for a first iterative update, the intermediate gas mixing parameter refers to a gas mixing parameter for second and subsequent iterative updates, and the intermediate gas mixing parameter refers to a gas mixing parameter used by the gas mixing device for next gas mixing;
in response to determining that intermediate gas data does not satisfy the preset condition, determine a compliance expectation for the gas mixing parameter and/or the intermediate gas mixing parameter, the intermediate gas data being gas composition data obtained for the current gas mixing, and the compliance expectation including a duration required for the intermediate gas data to satisfy the preset condition;
adjust, based on the compliance expectation, the gas mixing parameter and/or the intermediate gas mixing parameter to determine an intermediate gas mixing parameter for a next iterative update, and perform the next iterative update; and
in response to determining that the intermediate gas data satisfies the preset condition, end the at least one iterative update, and determine the gas mixing parameter and/or the intermediate gas mixing parameter as the updated gas mixing parameter.

14-15. (canceled)

16. The IoT system of claim 11, wherein the gas company management platform is further configured to:
determine, based on the output composition data and the downstream pipeline data, composition influence data through the gas database, the composition influence data referring to data featuring the impact of the downstream gas pipeline on the composition of the output gas after the gas mixing station transports the output gas based on the gas transportation parameter; and
determine, based on the composition influence data and the output composition data, the gas transportation parameter, the gas transportation parameter referring to a parameter related to the delivery of the output gas to a plurality of downstream gas pipelines.

17. (canceled)

18. The IoT system of claim 16, wherein the gas company management platform is further configured to:
construct, based on the composition influence data, the downstream pipeline data, and the output composition data, a gas transportation map, the gas transportation map referring to a graph structure that characterizes a correlation between a gas mixing station and a downstream station; and
determine, based on the gas transportation map, the gas transportation parameter through a transportation model, the transportation model being a machine learning model.

19-20. (canceled)
